(19) United States
(12) Patent Application Publication
(10) Pub. No.: US 2021/0331307 A1
(43) Pub. Date: Oct. 28, 2021

(54) CONTROLLER, ADJUSTMENT DEVICE, AND ADJUSTMENT SYSTEM

(71) Applicant: INDUSTRY-UNIVERSITY COOPERATION FOUNDATION HANYANG UNIVERSITY ERICA CAMPUS, Ansan-si (KR)

(72) Inventors: Chang Soo HAN, Seoul (KR); Yong Seok LEE, Ansan-si (KR); Sang Ho KIM, Ansan-si (KR); Dong Ik SUN, Ansan-si (KR); Sang Keun LEE, Ansan-si (KR); Jin Sung PARK, Ansan-si (KR)

(73) Assignee: INDUSTRY-UNIVERSITY COOPERATION FOUNDATION HANYANG UNIVERSITY ERICA CAMPUS, Ansan-si (KR)

(21) Appl. No.: 17/368,181

(22) Filed: Jul. 6, 2021

Related U.S. Application Data
(63) Continuation of application No. PCT/KR2019/005496, filed on May 8, 2019.

(30) Foreign Application Priority Data
Jan. 4, 2019 (KR) 10-2019-0001025

(51) Int. Cl. B25J 3/00; B25J 13/00; B25J 13/02

(52) U.S. Cl. CPC B25J 3/00; B25J 13/02; B25J 13/006

(57) ABSTRACT

Provided is a controller for remotely controlling a controlled object comprising: a main body; a controlled material; and a manipulator for connecting the main body and the controlled material and defining a position of the controlled material from the main body, wherein the controller may comprise: a fixed part; a handle part having a predetermined degree of freedom with respect to the fixed part; and a control signal generating unit for generating a control signal such that when the handle part is manipulated in a predetermined manipulation direction with respect to the fixed part, a control point provided on one side of the controlled material is controlled in the same direction as the manipulation direction.

### TECHNICAL FIELD

The present invention relates to a controller, an adjustment device, and an adjustment system, and more particularly, to a controller, an adjustment device, and an adjustment system to intuitively control an object to be controlled such as heavy equipment.

### BACKGROUND ART

In general, heavy equipment collectively refers to heavy machinery used in construction and civil engineering works, and includes excavators, bulldozers, forklifts, and loaders. The excavators among heavy equipment, as widely used equipment in various industrial sites, refer to construction machines that perform work such as excavating work of digging the ground, loading work of transporting soil, shredding work of dismantling buildings, and cleanup work of cleaning the ground, and are called the so-called Poclain or backhoe. In the excavator, a driver sits on a driver's seat and manipulates a control lever installed in the excavator to perform work.

Since the working environment requires a high degree of safety for controlling the heavy equipment, there is a technical demand for remote control. However, in the conventional remote control, the operator may not smoothly perform operations due to the control of heavy equipment and feel unnatural senses.

In addition, there is also a demand for technology to remotely control a plurality of heavy equipment in addition to controlling one heavy equipment.

Accordingly, the inventors invented a controller, an adjustment device, and an adjustment system to facilitate intuitive remote control and multi-control.

### DISCLOSURE

### Technical Problem

One technical problem to be solved by the present invention is to provide a controller, an adjustment device, and an adjustment system to facilitate intuitive remote control.

Another technical problem to be solved by the present invention is to provide a controller, an adjustment device, and an adjustment system to have a simple control interface.

Still another technical problem to be solved by the present invention is to provide a controller, an adjustment device, and an adjustment system to facilitate remote control with multiple degrees of freedom.

Still another technical problem to be solved by the present invention is to provide a controller, an adjustment device, and an adjustment system to improve work environment convenience for operators.

The technical problem to be solved by the present invention is not limited to the above technical problems, and will be clearer by the following description.

The controller according to one embodiment of the present invention includes: a fixed part; a handle part having a predetermined degree of freedom with respect to the fixed part; and a control signal generating unit for generating a control signal such that a controlled point provided on one side of the controlled material is controlled in the same direction as the manipulation direction, when the handle part is manipulated in a predetermined manipulation direction with respect to the fixed part.

The controlled object may include: a main body; a controlled material; and a manipulator for connecting the main body and the controlled material and defining a position of the controlled material from the main body.

According to one embodiment, the control signal may be a signal for controlling postures of the manipulator so that the controlled point is controlled in the same direction as the manipulation direction.

According to one embodiment, the manipulator may include at least two links for connecting the main body and the controlled material, and the control signal may be a signal for controlling postures of at least one of the at least two links such that the controlled point is controlled in the same direction as the manipulation direction.

According to one embodiment, one of the two links may be a boom, the other may be an arm, and the controlled material may be a bucket.

According to one embodiment, the predetermined degree of freedom may include two translational degrees of freedom for the handle part relative to the fixed part, and one rotational degree of freedom for rotating the handle part about a longitudinal direction as an axis with respect to the fixed part.

According to one embodiment, when the handle part is manipulated according to the translational freedom with respect to the fixed part, the control signal may be a signal for controlling postures of the manipulator such that the controlled point is controlled in a manipulation direction according to the translational degree of freedom.

According to one embodiment, when the handle part is manipulated according to the rotational degree of freedom with respect to the fixed part, the control signal may be a signal for controlling the bucket in a manipulation direction according to the rotational degree of freedom.

According to one embodiment, the present invention may further include a support arm having one end connected to the fixed part and the other end which is swingable, and the control signal generating unit may further generate a control signal for swinging the main body about an axis in a height direction of the main body, when the support arm is manipulated to be swung.

According to one embodiment, the support arm may extend in the longitudinal direction of the operator's arm, and an arm support on which the operator's arm is mounted may be provided on one surface of the support arm.

According to one embodiment, the controlled object may include a first controlled object and a second controlled object, the fixed part may include a fixed part fixed part and a second fixed part facing the first fixed part the handle part may include a first handle part having a predetermined degree of freedom with respect to the first fixed part, and a second handle part having a predetermined degree of freedom with respect to the second fixed part, and the control signal generating unit may generate a first control signal such that a first controlled point provided on the first controlled material of the first controlled object is controlled in the same direction as the first manipulation direction, when the first handle part is manipulated in a first manipulation direction with respect to the first fixed part, and may generate a second control signal such that a second controlled point provided on the second controlled material of the second controlled object is controlled in the same direction as the second manipulation direction, when the second handle part is manipulated in a second manipulation direction with respect to the second fixed part.

According to one embodiment, the control signal generating unit may generate the control signal based on information about the manipulation direction and speed information of the handle part with respect to the fixed part.

The adjustment device according to one embodiment of the present invention may include: a communication unit for receiving a control signal in a specific direction for a controlled point provided on one side of the controlled material from the outside; and a driving control unit for controlling a posture of the manipulator such that the controlled point is controlled in the specific direction.

The controlled object may include: a main body; a controlled material; and a manipulator for connecting the main body and the controlled material and defining a position of the controlled material from the main body.

According to one embodiment, the manipulator may include at least two links for connecting the main body and the controlled material, wherein, when the control signal includes a signal for controlling a translational movement of the controlled point, the driving control unit may control postures of at least one of the two links so that the controlled point moves only in translation.

According to one embodiment, when the control signal includes a signal for controlling the rotation of the controlled material, the driving control unit may rotate the controlled object while the position of the controlled material is fixed.

According to one embodiment, when the control signal includes a signal for controlling the swing of the main body, the driving control unit may control the swing of the main body about the axis in the height of the main body.

According to one embodiment, the controlled object may include a first controlled object and a second controlled object, and the control signal may be a signal for controlling both of the controlled point of the first controlled object and the controlled point of the second controlled object.

The adjustment system according to one embodiment of the present invention may include a controller including a fixed part, a handle part having a predetermined degree of freedom with respect to the fixed part, and a control signal generating unit for generating a control signal such that a controlled point provided on one side of the controlled material is controlled in the same direction as the manipulation direction, when the handle part is manipulated in a predetermined manipulation direction with respect to the fixed part; and a driving control unit for controlling the position of the manipulator according to the control signal.

The controlled object may include a main body; a controlled material; and a manipulator for connecting the main body and the controlled material and defining a position of the controlled material from the main body.

According to one embodiment, when the handle part is manipulated to move in a translational direction with respect to the fixed part, the driving control unit may control the controlled point only in the translational direction.

According to one embodiment, when the handle part is manipulated to be rotated with respect to the fixed part, the driving control unit may control the controlled material in the rotational direction in place.

According to one embodiment, the controller may further include a support arm having one end connected to the fixed part and the other end which is swingable, and the driving control unit may control the main body to be swung about the axis in the height direction of the main body, when the support arm is manipulated to be swung.

### Technical Solution

According to one embodiment of the present invention, the controller manipulation and the controlled direction of the controlled material match each other, so that intuitive remote control can be facilitated.

According to one embodiment of the present invention, the remote control manipulation of 2 translational degrees of freedom and 1 rotational degree of freedom may be performed through the handle part of the controller, so that the remote control with multiple degrees of freedom can be facilitated through a simple interface.

According to one embodiment of the present invention, the swing rotation of the controlled object can be controlled through the rotation of the arm, and the remote control environment with multiple degrees of freedom can be provided.

The advantageous effects of the present invention are not limited to the above-described effects, and will be clearer by the following description.

### Advantageous Effects

FIG. 1 is a view showing a heavy equipment adjustment system according to one embodiment of the present invention.

FIG. 2 shows a block diagram the heavy equipment adjustment system according to one embodiment of the present invention.

FIG. 3 is a view for explaining a controller according to one embodiment of the present invention.

FIG. 4 is a view for explaining a degree of freedom of remote control of the controller according to one embodiment of the present invention.

FIGS. 5 to 8 are views for explaining operations of remote control according to one embodiment of the present invention.

FIGS. 9 and 10 are views for explaining multi remote control according to one embodiment of the present invention.

### DESCRIPTION OF DRAWINGS

FIG. 1 is a view showing a heavy equipment adjustment system according to one embodiment of the present invention.

FIG. 2 shows a block diagram the heavy equipment adjustment system according to one embodiment of the present invention.

FIG. 3 is a view for explaining a controller according to one embodiment of the present invention.

FIG. 4 is a view for explaining a degree of freedom of remote control of the controller according to one embodiment of the present invention.

FIGS. 5 to 8 are views for explaining operations of remote control according to one embodiment of the present invention.

FIGS. 9 and 10 are views for explaining multi remote control according to one embodiment of the present invention.

### BEST MODE

Hereinafter, preferred embodiments of the present invention will be described in detail with reference to the accompanying drawings. However, the technical idea of the present invention is not limited to the exemplary embodiments described herein and maybe embodied in other forms. Further, the embodiments disclosed thoroughly and completely herein may be provided such that the idea of the present invention can be fully understood by those skilled in the art.

In the specification herein, when one component is mentioned as being on the other components, it signifies that the one component may be placed directly on the other components or a third component may be interposed therebetween. Further, in drawings, shapes and sizes may be exaggerated to effectively describe the technical content of the present invention.

In addition, although terms such as first, second and third are used to describe various components in various embodiments of the present specification, the components will not be limited by the terms. The above terms are used merely to distinguish one component from another. Accordingly, a first component referred to in one embodiment may be referred to as a second component in another embodiment. Each embodiment described and illustrated herein may also include a complementary embodiment. In addition, the term “and/or” is used herein to include at least one of the components listed before and after the term.

The singular expression herein includes a plural expression unless the context clearly specifies otherwise. In addition, it will be understood that the term such as “include” or “have” herein is intended to designate the presence of feature, number, step, component, or a combination thereof recited in the specification, and does not preclude the possibility of the presence or addition of one or more other features, numbers, steps, components, or combinations thereof. In addition, the term “connection” is used herein to include both indirectly connecting a plurality of components and directly connecting the components.

In addition, in the following description of the embodiments of the present invention, the detailed description of known functions and configurations incorporated herein will be omitted when it possibly makes the subject matter of the present invention unclear unnecessarily.

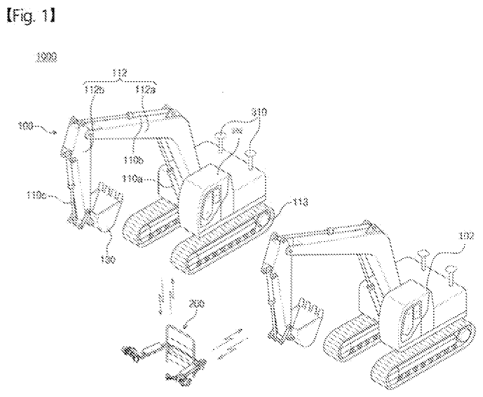

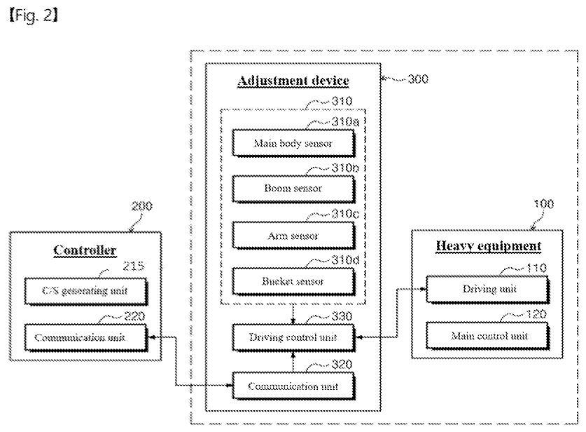

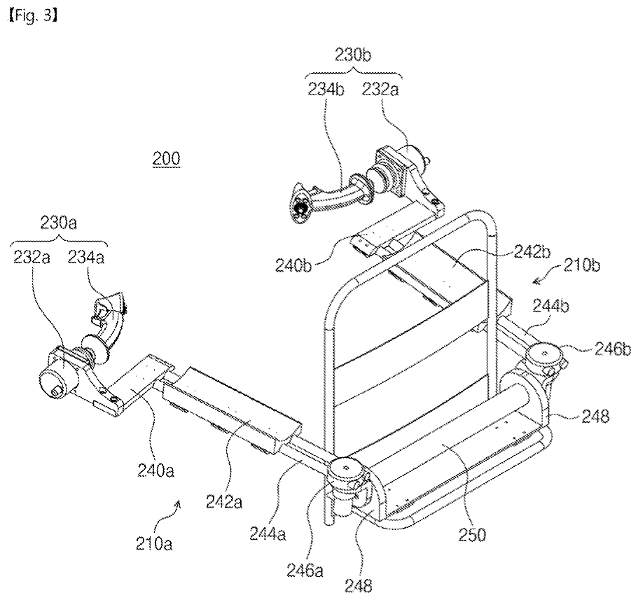

FIG. 1 is a view showing a heavy equipment adjustment system according to one embodiment of the present invention. FIG. 2 shows a block diagram the heavy equipment adjustment system according to one embodiment of the present invention. FIG. 3 is a view for explaining a controller according to one embodiment of the present invention.

Referring to FIGS. 1 and 2, the adjustment system 1000 according to one embodiment of the present invention may include at least one of a controlled object 100, a controller 200, and an adjustment device 300.

According to one embodiment of the present invention, the controlled object 100 may be controlled according to a remote control signal generated by the controller 200. The control device 300 may control the controlled object 100 based on the control signal generated from the controller 200.

In the specification herein, the controlled object refers to an object remotely controlled according to a control signal generated from the controller 200, for example, may include heavy equipment. Hereinafter, it is assumed that the controlled object is heavy equipment for convenience of description.

Heavy Equipment 100

For performing work, the heavy equipment 100 may include at least one of a main body 102, a manipulator 112, a traveling member 113, a driving unit 110, and a main control unit 120.

The main body 102 may be provided to have a predetermined volume. The main body 102 may have a boarding space in which an operator manipulates the heavy equipment 110.

The manipulator 112 is provided to be connected to the main body 102 to perform the predetermined work. To this end, the manipulator 112 may include at least two links, for example, a boom 112a and an arm 112b. The boom 112a has a predetermined length, and has one end rotatably connected to the main body 102. The boom 112a may be provided in a bent structure from one point in the longitudinal direction. The arm 112b has a predetermined length, and has one end rotatably connected to the other end of the boom 112a.

A controlled object, for example, a bucket 130 may be positioned at one end of the arm 112b of the manipulator 112. The bucket 130 is formed with an accommodation space for digging the ground or loading the soil, and rotatably connected to the other end of the arm 112b.

Since the bucket 130 is provided at one end of the manipulator 112, the position of the bucket 130 may be defined by a posture of the manipulator 112. In other words, postures of the boom 112a and the arm 112b constituting the manipulator 112 may determine a spatial position of the bucket 130.

A controlled point may be provided on one side of the bucket 130 serving as a controlled material, and the controlled point may function as a reference point controlled by the controller 200, so that a remote control can be implemented. The remote control based on the controlled point will be described later in detail.

The driving unit 110 may change postures of the manipulator 112 and/or the bucket 130. To this end, the driving unit 110 may include a boom driving unit 110a, an arm driving unit 110b, and a bucket driving unit 110c.

The boom driving unit 110a may provide power for driving the boom 112a with respect to the main body 102. According to an embodiment of the present invention, the boom driving unit 110a may be provided in a cylinder structure, in which one side end may be connected to the main body 102 and the other end may be connected to the boom 112a. Accordingly, the posture of the boom 112a may be controlled by controlling a length of the boom driving unit 110a.

The arm driving unit 110b provides power for driving the arm 112b with respect to the boom 112a. The arm driving unit 110b may be provided in a cylinder structure, in which one end may be connected to the boom 112a and the other end may be connected to the arm 112b. Accordingly, the posture of the arm 112b may be controlled by controlling a length of the arm driving unit 110b.

The bucket driving unit 110c provides power for driving the bucket 130 with respect to the arm 112b. The bucket driving unit 110c may be provided in a cylinder structure, in which one end maybe connected to the arm 112b and the other end may be connected to the bucket 130. Accordingly, the posture of the bucket 130, specifically, the rotational posture may be controlled by controlling a length of the bucket driving unit 110c.

The traveling member 113 is connected to a lower portion of the main body 102 and provided to travel with respect to the ground, so that the heavy equipment 110 is allowed to travel for position movement. The traveling member 113 and the main body 102 may be provided to be relatively rotatable about a shaft provided in a vertical direction. For example, the traveling member 113 may be configured to include caterpillars, wheels, and the like.

The main control unit 120 may generate an electrical signal for controlling the components of the heavy equipment 110. For example, the main control unit 120 may perform an operation according to a control signal generated within a working space of the heavy equipment 100. More specifically, when the operator manipulate the heavy equipment 100 while being positioned in the main body 102, the main control unit 120 may control each component, such as the driving unit 110, of the heavy equipment 100 in response to the manipulation of the operator, thereby determining postures of the manipulator 120 and the bucket 130.

Further, according to one embodiment of the present invention the heavy equipment 100 may perform the operation according to the control signal generated from the controller 200. Hereinafter, the controller 200 according to one embodiment of the present invention will be described with reference to FIGS. 2 and 3.

Controller 200

Referring to FIGS. 2 and 3, the controller 200 according to one embodiment of the present invention may include at least one of an input module 210, a control signal generating unit 215, and a communication unit 220.

The input module 210 shown in FIG. 3 may include a hardware configuration which the operator may remotely manipulate. For example, the operator may place the arms on the input module 210 and then manipulate the input module 210 in desired directions. The input module 210 may be provided with two input modules to correspond to the left and right arms, so as to spaced apart from each other by a predetermined distance in left and right directions. This may be understood that a plurality of heavy equipment are configured to be simultaneously controlled. The input module 210 also may be prepared to correspond to the left arm or the open arm.

The input module 210 may include a first input module 210a and a second input module 210b, and each input module may provide signals for remotely controlling each heavy equipment. Hereinafter, for convenience of description, the first input module 210a and the second input module 210b will be described as the input module 210 without distinction therebetween.

Hereinafter, the direction in which the input modules 210 are spaced apart from each other will be called the left-right direction, and the direction perpendicular to the left-right direction on a plane will be called the back-forth direction. In addition, the direction in which the control member 230 is positioned in the back-forth direction is referred to as a front.

A connecting shaft 250 may be provided to have a predetermined length, in which a lengthwise direction is directed in the left-right direction. Ends of the connecting shaft 250 are connected to rear ends of the input modules 210, respectively, so that the input modules 210a and 210b spaced apart in the left-right direction are connected to each other. The connecting shaft 250 may be provided to be supported by a frame 248.

The input module 210 may include a control member 230 and a support arm 244.

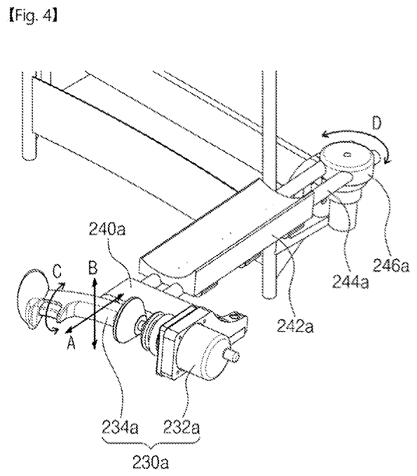

The control member 230 may be provided such that the operator may input a signal for controlling the heavy equipment 110 while gripping the control member using a hand. The control member 230 includes a fixed part 232 and a gripping part 234. The gripping part 234 is provided to extend outward by a predetermined length from one side of the fixed part 232. The gripping part 234 is provided to be movable with respect to the fixed part 232 with a predetermined degree of freedom. For example, as shown in FIG. 4, the gripping part 234 may be provided so as to move in a back-forth direction A and an up-down direction B with respect to the fixed part 232. In addition, the gripping part 234 may be provided to be rotated C with respect to the fixed part 232 about an axis parallel to the lengthwise direction thereof.

The support arm 244 is provided to have a predetermined length, so that a front end of the support arm 244 is connected to the fixed part 232 of the control member 230. A rear end of the support aim 244 may be connected to the connecting shaft 250.

An arm support 242 may be provided at one point in the lengthwise direction of the support arm 244. The arm support 242 may be provided in the form of a plate having a predetermined area. An upper surface of the arm support part 242 may be formed with a groove concave downward to correspond to a shape of the operator's arm. Accordingly, the operator may perform remote control tasks while maintaining the arm in a comfortable posture. The arm support 242 may be provided to be aligned with the gripping part 234 in the lengthwise direction. For example, a fastening auxiliary part 240 bent outwardly with respect to the lengthwise direction of the support arm 244 may be formed at the front end of the support arm 244. In addition, the control member 230 may be fixed to the fastening auxiliary part 240.

A rotating member 246 may be provided at a rear end of the support arm 244. Based on when the lengthwise direction of the support arm 244 is positioned on a horizontal plane, the rotating member 246 may be rotated about an axis provided with the support arm 244 in the vertical direction, that is, an axis D of FIG. 4.

The control signal generating unit 225 may generate a control signal in response to the manipulation of the back-forth direction A, the up-down direction B, the rotational direction C of the gripping part 234 and the manipulation of the rotational direction D of the rotating member 246.

The control signal may be a signal for controlling the controlled point of the heavy equipment 100 in the back-forth direction A when the gripping part 234 is manipulated in the back-forth direction A, may be a signal for controlling the controlled point of the heavy equipment 100 in the up-down direction B when the gripping part 234 is manipulated in the up-down direction B, and may be a signal for controlling the rotation C of the controlled point when the gripping part 234 is manipulated in the rotational direction C. In addition, the control signal may be a signal for controlling the heavy equipment 100 so as to be swung about an axis in the height direction of the heavy equipment 100, when the rotating member 246 is manipulated to be rotated.

The control signal generating unit 220 may include sensor so as to detect the amount of manipulation in the back-forth direction A, the up-down direction B, and the rotational direction C of the gripping part 234 and the amount of manipulation in the rotational direction D of the rotating member 246.

The control signal generated by the control signal generating unit 220 may be provided to the adjustment device 300 through the communication unit 220.

Adjustment Device 300

As shown in FIG. 2, the adjustment device 300 may include at least one of a sensor 310, a driving control unit 330, and a communication unit 320.

The adjustment device 300 may receive the control signal from the controller 200 to control each component of the heavy equipment 100 according to the received control signal. Hereinafter, each component will be described.

The sensor 310 may sense data on a status of the heavy equipment 110 and provide the data to the driving control unit 330. The sensor 310 may include a main body sensor 310a, a boom sensor 310b, an arm sensor 310c, and a bucket sensor 310d.

The main body sensor 310a may be positioned in the main body 102 to provide the driving control unit 330 with data on a position of a point in which the main body sensor 310a is installed. The main body sensor 310a may be provided as a GPS receiver to provide coordinate data on the location of the point installed in the main body 102. The main body sensor 310a may be provided with two main body sensors to be spaced apart from each other by a predetermined distance.

The boom sensor 310b may be positioned in the boom 112a to detect the posture of the boom 112a. For example, the boom sensor 310b may be provided as an inertial measurement unit (IMU) and may be provided to detect the speed, direction, slope, gravity, and acceleration of the boom 112a. The boom sensor 310b may be provided detachably.

The arm sensor 310c may be positioned in the arm 112b to detect the posture of the arm 112b. For example, the arm sensor 310c may be provided as an inertial measurement unit (IMU) and may be provided to detect the speed, direction, slope, gravity, and acceleration of the arm 112b. The arm sensor 310c may be provided detachably.

The bucket sensor 310d may be positioned in the bucket 130 to detect the posture of the bucket 130. For example, the bucket sensor 310d may be provided as an inertial measurement unit (IMU) and may be provided to detect the speed, direction, slope, gravity, and acceleration of the bucket 130. The bucket sensor 310d may be provided detachably.

The communication unit 320 may receive a signal from the outside. For example, the communication unit 320 may receive the control signal through the communication unit 220 of the controller 200. The control signal received from the communication unit 320 may be provided to the driving control unit 330.

The driving control unit 330 may control each component of the heavy equipment 100 in response to the signal received from the main control unit 120 of the heavy equipment 100. Further, the driving control unit 330 may control each component of the heavy equipment 100 according to the remote control signal from the controller 200. The driving control unit 330 may perform the remote control more accurately based on the signal detected from the sensor 310. In other words, when performing the remote control according to the control signal from the controller 200 the driving control unit 330 may apply the signal received from the sensor 310.

More specifically, the driving control unit 330 may sense the posture of the main body 102 or the direction faced by the manipulator 112 through the data provided by the main body sensor 310a. Specifically, the driving control unit 330 may calculate the relationship in which the two main body sensors 310a are arranged on a plane, through position data provided by the two main body sensors 310a. Accordingly, the posture of the main body 102 may be calculated.

The driving control unit 330 may detect the position of the bucket 130 with respect to the main body 102 through the data provided by the boom sensor 310b and the arm sensor 310c. Specifically, the driving control unit 330 may have data on the length of the boom 112a and the length of the arm 112b. In addition, the driving control unit 330 may calculate the position of the bucket 130 with respect to the main body 102 through slope values provided by the boom sensor 310b and the arm sensor 310c. In addition, the driving control unit 330 may calculate the posture of the bucket 130 through the data provided by the bucket sensor 310d.

In addition, the driving control unit 330 may control the driving unit 110. For example, the driving control unit 330 may control the driving unit 110 according to the remote control signal from the controller 200. According to one embodiment, the driving control unit 330 may directly control the driving unit 110, or may allow the main control unit 120 to control the driving unit 110.

The adjustment device 300 may be configured to be detachable to the heavy equipment 100. In other words, the adjustment device 300 may be provided as a combination additionally coupled to the heavy equipment 100. In other words, FIG. 2 shows the adjustment device 300 as a component separate from the heavy equipment 100, however, the adjustment device 300 may be included as one component of the heavy equipment 100.

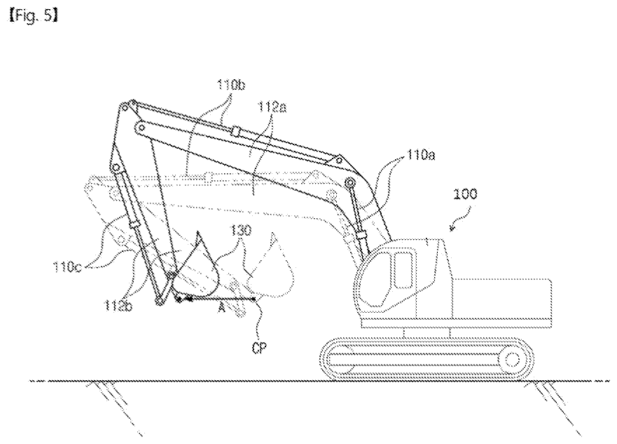

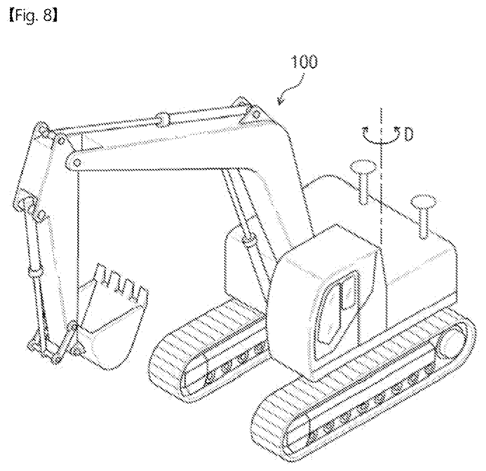

Hereinafter, the manipulation of the controller 200 according to one embodiment of the present invention with reference to FIG. 4, and the remote control of the controlled point by manipulating the controller 200 with reference to FIGS. 5 to 8 will be described.

FIG. 4 is a view for explaining a degree of freedom of the remote control of the controller according to one embodiment of the present invention. FIGS. 5 to 8 are views for explaining operations of remote control according to one embodiment of the present invention.

Referring to FIG. 4, the manipulation may be applied to the gripping part 234 of the controller 200 in the front-back direction A, the up-down direction B, and the rotational direction C by the operator, and the manipulation may be applied to the rotating member 246 in the rotational direction D.

In the above case, the control signal generating unit 215 may detect the direction and the degree of speed of manipulation. The control signal generating unit 215 may provide a control signal including information on the manipulation to the driving control unit 330 through the communication units 220 and 320.

The driving control unit 330 may perform the remote control by controlling the driving unit 110 according to the control signal. More particularly, according to one embodiment of the present invention, the remote control may be performed such that the controlled point of the heavy equipment 100 is controlled in the same direction as the manipulation direction generated in the controller 100.

The driving control unit 330 may remotely control the bucket 130 in response to the manipulation signal inputted through the controller 100, in which the control may be performed according to the orthogonal coordinate system. In other words, when the gripping part 234 is controlled to move in a specific direction, the driving control unit 330 may control the boom 112a and/or the arm 112b so as to move the controlled point CP of the bucket 130 only in the specific direction. Accordingly, since the direction in which the operator manipulates the gripping part 234 and the control direction of the controlled point CP are the same, the intuitive remote control environment may be provided.

More specifically, when the manipulation occurs in the back-forth direction A shown in FIG. 4, the driving control unit 330 may control the boom driving unit 110a and the arm driving unit 110b of the driving unit 110. Accordingly, the posture of the manipulator 112 is controlled, so that the controlled point CP provided on one side of the bucket 130 may move in an arrow direction A of FIG. 5. The lengths of the boom driving unit 110a and the arm driving unit 110b is controlled to allow the controlled point CP to move in the direction A. Accordingly, the orthogonal remote control, in which the manipulation direction and the control direction of the controlled point are maintained in the same manner, may be performed. Further, the driving control unit 330 may control the bucket driving unit 110c, such that a change in a rotational state of the bucket 130 may not occur.

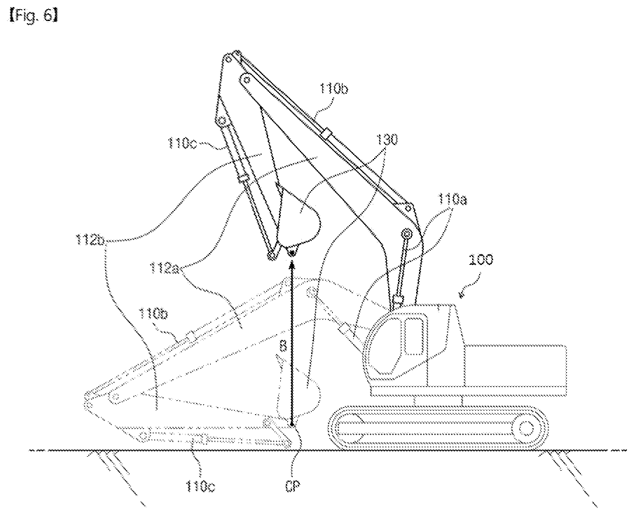

When the manipulation occurs in the up-down direction B shown in FIG. 4, the driving control unit 330 may control the boom driving unit 110a and the arm driving unit 110b of the driving unit 110, so that the controlled point CP provided on the one side of the bucket 130 may move in an arrow direction B of FIG. 6. The lengths of the boom driving unit 110a and the arm driving unit 110b is controlled to allow the controlled point CP to move in the direction B. Further, the driving control unit 330 may control the bucket driving unit 110c, such that a change in a rotational state of the bucket 130 may not occur.

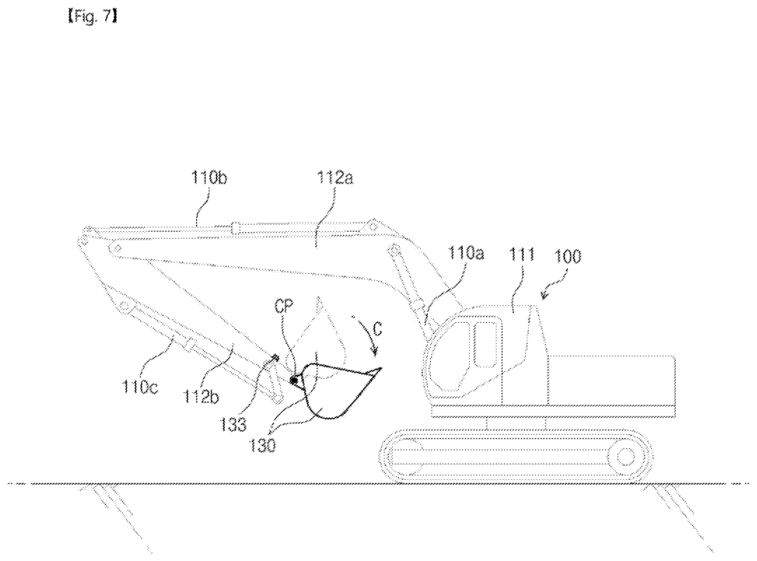

In addition, when the gripping part 234 of FIG. 4 is manipulated in the rotational direction C, the driving control unit 330 may control the bucket driving unit 112c of the driving unit 110, so that the bucket 130 may be rotated in an arrow direction C of FIG. 7. Only the rotation may be conducted without the translational movement of the controlled point CP.

In addition, when the rotating member 246 of FIG. 4 is manipulated in the rotational direction D, the driving control unit 330 may control the traveling member 130, so that the heavy equipment 100 may be controlled to be swung about an axis D in the height direction of the heavy equipment 100.

It has been described above about the remote-control direction of the controlled point and the heavy equipment in response to the manipulation direction of the controller. Hereinafter, the degree of controlling the controlled point and the heavy equipment in response to the manipulation of the controller will be described. The degree of controlling in response to the manipulation of the controller may be implemented by the control signal generating unit 215 of the controller 200, or may be implemented by the driving control unit 330 of the adjustment device 300. Hereinafter, for convenience of description, it is assumed that the driving control unit 330 acquires the control amount of the controlled point CP.

The driving control unit 330 may acquire information on the amount of manipulation from the control signal generating unit 215 about the direction and speed of manipulation of the operator, through the communication unit 320. According to one example the driving control unit 330 may acquire the manipulated amount information through the control signal.

The driving control unit 330 may acquire the manipulated amount of the controlled point CP, that is, the controlled amount, based on the operator's manipulation speed applied to the controller 100. According to one embodiment, the driving control unit 330 may acquire the controlled amount through the moving speed of the gripping part 234 inputted through the controller 200. Specifically, the driving control unit 330 may calculate a target position value by which the controlled point of the bucket 130 is required to move by performing an integral operation on speed data of the gripping part 234 received from the control signal generating unit 110. In another aspect, when the moving speed of the gripping part 234 is increased, the moving distance of the controlled point may be increased. On the contrary, when the moving speed of the gripping part 234 is decreased, the moving distance of the controlled point maybe decreased. In other words, the driving control unit 330 may perform the integral operation on the moving speed of the gripping part, and may calculate the target position value to which the controlled point of the bucket 130 is required to reach, in proportion to the integrally operated value. Accordingly, the driving control unit 330 may acquire the information on the controlled amount of the controlled point.

Further, the driving control unit 330 may continuously calculate the moving distance value to which the bucket 130 is required to move, by comparing the position of the bucket 130 with the target position value calculated through the data provided by the sensor 310. The continuous feedback control may be conducted through the comparison between the calculated position with the target position of the bucket 130, so that the accurate positional movement of the bucket 130 can be achieved.

The driving control unit 330 may control the driving unit 110 to move the bucket 130 according to the moving distance value, so that the boom 112a or the arm 112b may be driven, or the boom 112a and arm 112b may be driven.

The driving control unit 330 may acquire information on the rotational amount of the bucket 130 and the swing amount of the heavy equipment 100, based on the rotational speed of the gripping part 234 and the rotating member 246 in the same manner. Specifically, the driving control unit 330 may calculate a target rotation value by which the bucket 130 is required to be rotated, by performing an integral operation on rotational speed data of the gripping part 234 received from the control signal generating unit 225. In addition, the driving control unit 330 may control the driving unit 110 such that the bucket 130 may be rotated according to the calculated angle value. In the same manner, the driving control unit 330 may calculate a target swing rotation value by which the heavy equipment is required to be swung and rotated, by performing an integral operation on rotational speed data of the rotating member 246. In addition, the driving control unit 330 may control the driving member 130 such that the heavy equipment may be rotated according to the calculated swing rotation value.

The driving control unit 330 may control each component of the heavy equipment 100 based on the controlled amount obtained in the above manner. Accordingly, the more delicate remote control may be facilitated.

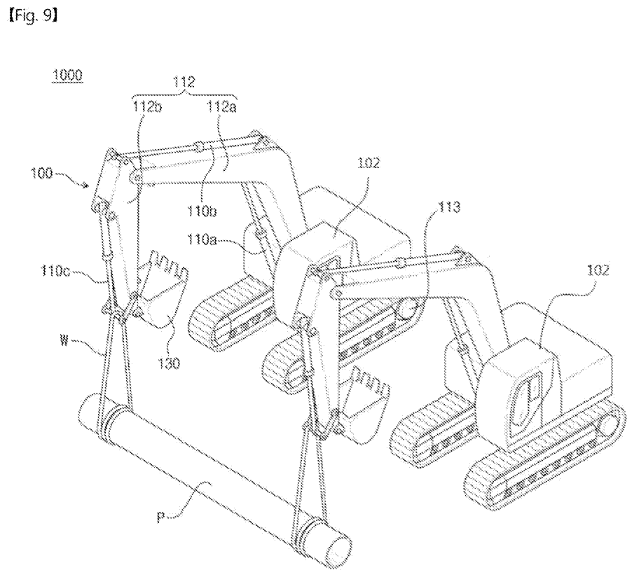

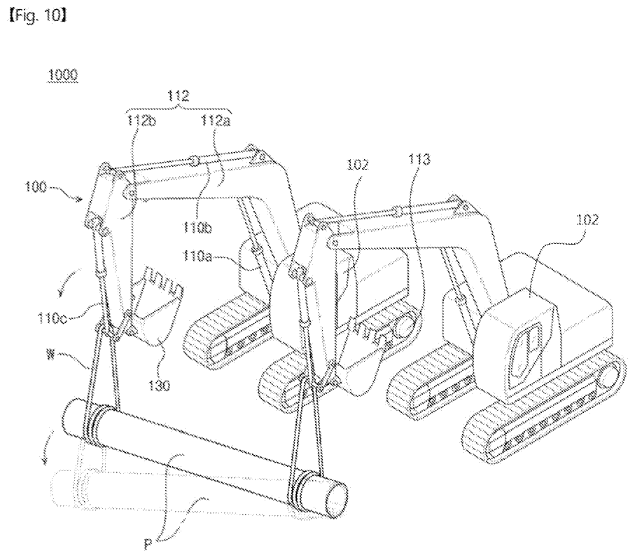

FIGS. 9 and 10 are views for explaining multi remote control according to one embodiment of the present invention. More specifically, FIG. 9 is a view showing a state in which the work is conducted by two heavy equipment. FIG. 10 is a view showing a state in which the heavy equipment are operated to adjust a position of a work object.

Referring to FIGS. 9 and 10, the heavy equipment control system 1000 according to the present invention may be controlled such that the two heavy equipment 100 may be operated in conjunction with each other. Specifically, as shown in FIG. 3, the operator may manipulate the input module 210a positioned on the left side of the input module 210 and the input module 210b positioned on the right side of the input module 210 by using the left arm and the right arm, respectively. The signal inputted through the input module 210a on the left side and the signal inputted through the input module 210b on the right side by the operator are transmitted to the corresponding heavy equipment, respectively. For example, the signal inputted through the input module 210a on the left may be transmitted to the corresponding heavy equipment 110 (heavy equipment 110 at the lower right in FIG. 9), and the signal inputted through the right input module 210b may be transmitted to the corresponding heavy equipment. In addition, as illustrated in FIG. 10, when a pipe P is suspended through wires W on the two heavy equipment 100, the operator may move the manipulator 112 of the heavy equipment 100 to correspond to a moving action of the right arm, so that the position of the right side of the pipe P may be adjusted.

The adjustment system 1000 according to the present invention may be provided to enable one operator to control the two heavy equipment 100 by using the both arms. The heavy equipment 100 are controlled through the signals inputted through the actions of the arms of the operator, respectively. Accordingly, the operator can intuitively manipulate the two heavy equipment 100 operated in response to the actions of the both arms, so that the two heavy equipment 100 may be effectively operated in conjunction with each other.

In general, since the bucket functions as a manipulation tool, that is, as an end effector, the position and posture of the bucket for work are important control factors. According to one embodiment of the present invention, the controlled point, which is remotely controlled, is positioned on one side of the bucket provided at the end of the manipulator, so that the remote control environment, which conforms to the intention of the operator, may be provided. In other words, when the operator performs a translational manipulation through the controller, each posture of the links of the manipulator is automatically controlled such that the controlled point of the bucket is controlled in the translational manipulation direction. Accordingly, the intuitive remote control can be implemented.

Further, according to one embodiment of the present invention, not only the translational manipulation but also the rotational manipulation are facilitated through the handle part, so that the rotation control of the bucket can also be easily conducted with one hand.

In addition, according to one embodiment of the present invention, even the swing of heavy equipment may be controlled by rotating the arm, so that a high degree of freedom for the remote control can be provided.

In addition, according to one embodiment of the present invention, a plurality of heavy equipment may be controlled by simultaneously using the both arms, so that a high work convenience can be provided.

In addition, although not shown, the adjustment device 300 may further include a display unit. Accordingly, information about the status of the heavy equipment 100 may be displayed. Alternatively, the display unit may be provided in the controller 200 and/or the adjustment device 300.

The above detailed description are merely illustrative for the present invention. In addition, the above description is illustrative with the exemplary embodiments of the present invention, and the present invention may be used in various other combinations, modifications, and environments. In other words, the present invention may be changed or modified within the scope of the concept of the invention disclosed herein, the scope equivalent to the written disclosure, and/or the scope of skill or knowledge in the art. The written embodiments are intended to describe the best state for implementing the technical idea of the present invention, and various modifications required in the specific application fields and uses of the present invention are possible. Accordingly, the above detailed description of the present invention is not intended to limit the present invention through the disclosed embodiments. Further, the appended claims will be construed as including other embodiments.

1. A controller for remotely controlling a controlled object, the controller comprising:
a main body;
a controlled material; and
a manipulator for connecting the main body and the controlled material and defining a position of the controlled material from the main body, wherein
the controller includes:
a fixed part;
a handle part having a predetermined degree of freedom with respect to the fixed part; and
a control signal generating unit for generating a control signal such that a controlled point provided on one side of the controlled material is controlled in the same direction as the manipulation direction when the handle part is manipulated in a predetermined manipulation direction with respect to the fixed part.

2. The controller of claim 1, wherein the control signal includes a signal for controlling a posture of the manipulator such that the controlled point is controlled in the same direction as the manipulation direction.

3. The controller of claim 2, wherein the manipulator includes at least two links for connecting the main body and the controlled material, and the control signal includes a signal for controlling postures of at least one of the at least two links such that the controlled point is controlled in the same direction as the manipulation direction.

4. The controller of claim 3, wherein one of the two links includes a boom, a remaining includes an arm, and the controlled material includes a bucket.

5. The controller of claim 1, wherein the predetermined degree of freedom includes two translational degrees of freedom for the handle part relative to the fixed part,
and one rotational degree of freedom for rotating the handle part about a longitudinal direction as an axis with respect to the fixed part.

6. The controller of claim 5, wherein, when the handle part is manipulated according to the translational freedom with respect to the fixed part,
the control signal includes a signal for controlling a posture of the manipulator such that the controlled point is controlled in a manipulation direction according to the translational degree of freedom.

7. The controller of claim 5, wherein, when the handle part is manipulated according to the rotational degree of freedom with respect to the fixed part,
the control signal includes a signal for controlling the bucket in a manipulation direction according to the rotational degree of freedom.

8. The controller of claim 1, further comprising:
a support arm having one end connected to the fixed part and the other end which is swingable, wherein
the control signal generating unit further generates a control signal for swinging the main body about an axis in a height direction of the main body, when the support arm is manipulated to be swung.

9. The controller of claim 8, wherein the support arm extends in the longitudinal direction of the operator's arm, and an arm support on which the operator's arm is mounted is provided on one surface of the support arm.

10. The controller of claim 1, wherein the controlled object includes a first controlled object and a second controlled object,
the fixed part includes a fixed part fixed part and a second fixed part facing the first fixed part,
the handle part includes a first handle part having a predetermined degree of freedom with respect to the first fixed part, and a second handle part having a predetermined degree of freedom with respect to the second fixed part, and
the control signal generating unit generates a first control signal such that a first controlled point provided on the first controlled material of the first controlled object is controlled in a same direction as the first manipulation direction when the first handle part is manipulated in a first manipulation direction with respect to the first fixed part, and generates a second control signal such that a second controlled point provided on the second controlled material of the second controlled object is controlled in the same direction as the second manipulation direction when the second handle part is manipulated in a second manipulation direction with respect to the second fixed part.

11. The controller of claim 1, wherein the control signal generating unit generates the control signal based on information about the manipulation direction and the manipulation speed of the handle part with respect to the fixed part, in which a control amount of the controlled point is determined according to an integral of the manipulation speed.

12. An adjustment device controlling a controlled object and including a main body, a controlled material and a manipulator for connecting the main body and the controlled material and defining a position of the controlled material from the main body, the adjustment device comprising:
a communication unit for receiving a control signal in a specific direction for a controlled point provided on one side of the controlled material from the outside; and
a driving control unit for controlling a posture of the manipulator such that the controlled point is controlled in the specific direction.

13. The adjustment device of claim 12, wherein the manipulator includes at least two links for connecting the main body and the controlled material, and
the driving control unit controls postures of at least one of the two links so that the controlled point moves only in translation, when the control signal includes a signal for controlling a translational movement of the controlled point.

14. The adjustment device of claim 12, wherein, when the control signal includes a signal for controlling the rotation of the controlled material, the driving control unit rotates the controlled object while the position of the controlled material is fixed.

15. The adjustment device of claim 12, wherein, when the control signal includes a signal for controlling the swing of the main body, the driving control unit controls the swing of the main body about the axis in the height of the main body.

16. The adjustment device of claim 12, wherein the controlled object includes a first controlled object and a second controlled object, and
the control signal includes a signal for controlling both of the controlled point of the first controlled object and the controlled point of the second controlled object.

17. An adjustment system controlling a controlled object and including a main body, a controlled material, and a manipulator for connecting the main body and the controlled material and defining a position of the controlled material from the main body, the adjustment system comprising:
a controller including a fixed part, a handle part having a predetermined degree of freedom with respect to the fixed part, and a control signal generating unit for generating a control signal such that a controlled point provided on one side of the controlled material is controlled in the same direction as the manipulation direction when the handle part is manipulated in a predetermined manipulation direction with respect to the fixed part; and
a driving control unit for controlling the position of the manipulator according to the control signal.

18. The adjustment system of claim 17, wherein, when the handle part is manipulated to move in a translational direction with respect to the fixed part, the driving control unit controls the controlled point only in the translational direction.

19. The adjustment system of claim 17, wherein, when the handle part is manipulated to be rotated with respect to the fixed part, the driving control unit controls the controlled material in the rotational direction in place.

20. The adjustment system of claim 17, wherein the controller further includes a support arm having one end connected to the fixed part and the other end which is swingable, and
the driving control unit controls the main body to be swung about the axis in the height direction of the main body when the support arm is manipulated to be swung.
